(19) United States
(12) Patent Application Publication
(10) Pub. No.: US 2022/0153029 A1
(43) Pub. Date: May 19, 2022

(54) FLOATING PRINTHEAD SHIELD

(71) Applicant: Hewlett-Packard Development Company, L.P., Spring, TX (US)

(72) Inventors: Jeffrey Neal Daley, Vancouver, WA (US); Jacinto Berrios, San Diego, CA (US); Andrew Smith, Vancouver, WA (US)

(73) Assignee: Hewlett-Packard Development Company, L.P., Spring, TX (US)

(21) Appl. No.: 17/434,142

(22) PCT Filed: Jun. 21, 2019
(86) PCT No.: PCT/US2019/038577

§ 371 Date: Aug. 26, 2021

(51) Int. Cl. B41J 2/165

(52) U.S. Cl. CPC B41J 2/16505

(57) ABSTRACT

Examples for of a floating printhead shield for a printing device are described herein. In some examples, a printhead shield may be located between a printhead and a print zone. When in a printing position the printhead shield may engage the printhead. When in a retracted position the printhead shield may separate from the printhead.

### BACKGROUND

Printing devices may apply a print substance, which can include printing agents or colorants, to a print media such as paper. A printing substance may include a black print substance and/or color print substances. The printing device may include a printhead that transfers the print substance to the print media.

### BRIEF DESCRIPTION OF THE DRAWINGS

Various examples will be described below by referring to the following figures.

FIG. 1 is a simplified isometric view of an example of a printing device with a floating printhead shield;

FIG. 2 is an example flow diagram illustrating a method for actuating a printhead;

FIGS. 3A and 3B are examples illustrating a printhead and a printhead shield in a retracted position and a printing position;

FIG. 4 is a section view illustrating an example of a printhead shield and a printhead for a printing device; and

FIG. 5 is a perspective view illustrating an example of a printhead shield and a printhead for a printing device.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

### DETAILED DESCRIPTION

Printing devices—including printers, copiers, fax machines, multifunction devices including additional scanning, copying, and finishing functions, all-in-one devices, and pad printers to print images on three dimensional objects—apply a print substance, which can include printing agents or colorants, to a print media. As used herein, print media includes any suitable object or material to which a print substance from a printing device is applied. Examples of print substances include toner, liquid inks, or other suitable marking material that may or may not be mixed with fusing agents, detailing agents, or other materials and can be applied to the print media.

Printing devices may include a printhead. The printhead may control the transfer of a print substance to the print media. The printhead may include a number of fragile components. For example, printhead dies may be damaged by contact with print media.

Examples of a printhead shield to protect the printhead are described herein. In some examples, the printhead shield may be attached to the printing device in such a manner that the printhead shield floats (e.g., is suspended) in relation to the printhead. In some examples, the printhead shield may be a thin plate (e.g., a metal plate) that is located between the printhead and the print media.

The printhead may move from a first position (referred to herein as a retracted position) to a second position (referred to herein as a printing position) for printing. When in the printing position, the printhead may contact the printhead shield. When in the retracted position, the printhead may separate from the printhead shield to form a space. In some examples, a wiper and cap sled moves into the space between the printhead and printhead shield when the printhead is in the retracted position.

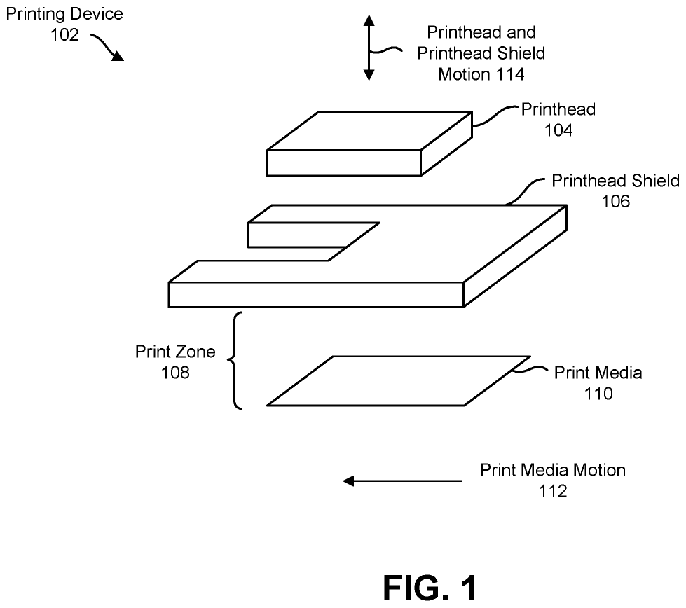

FIG. 1 is a simplified isometric view of an example of a printing device 102 with a floating printhead shield 106. Examples of the printing device 102 include printers, copiers, fax machines, multifunction devices including additional scanning, copying, and finishing functions, all-in-one devices, and pad printers.

In another example, the printing device 102 may be an overprinter. With overprinting, the printing device 102 may be mounted above a media transport. An example of a media transport includes a conveyor belt with a vacuum hold down to keep print media 110 in position. The conveyor belt may move the print media 110 under the printhead 104 for printing. An example of the print media motion 112 is illustrated in FIG. 1.

The printhead 104 may include components to transfer a print substance to the print media 110. For example, the printhead 104 may include a number of dies with nozzles to eject the print substance onto the print media 110.

Some components of the printhead 104 may be susceptible to damage. For example, the dies and other circuitry on the printhead 104 may be damaged if hit by print media 110. In some cases, the print media 110 may vary in thickness. For example, the print media 110 for overprinting may vary over a wide range to thicknesses. Therefore, the vertical position of the printhead 104 may depend on the print media 110 being printed. The print zone 108 may be an area in which printing occurs. The height of the print zone 108 may vary over a range to accommodate print media 110 with different thicknesses. Therefore, the printhead 104 may move vertically to different positions to print on the print media 110. The printhead motion 114 is depicted as movement along an axis (e.g., a vertical axis). The printhead motion 114 may be perpendicular to the print media motion 112.

The printing device 102 may include a printhead shield 106 that is located between the printhead 104 and the print zone 108. In other words, the printhead shield 106 may be situated between the printhead 104 and the print media 110 entering the print zone 108. The printhead shield 106 may protect the printhead 104 from the print media 110. In some examples, the printhead shield 106 may be fabricated from a metal plate (e.g., sheet metal). In other examples, the printhead shield 106 may be fabricated from other materials (e.g., a polymer).

In some examples, the printhead shield 106 may include an input side to hold down the print media 110 entering the print zone 108. The printhead shield 106 may also include an output side with an opening to permit transfer of a print substance from the printhead 104 to the print media 110. The opening of the printhead shield 106 may line up with the die of the printhead 104 to allow the print substance to transfer to the print media 110. It should be noted that in FIG. 1, the opening spans the entire output side of the printhead shield 106. In other examples, the printhead shield opening may be located within the interior of the printhead shield 106. In yet other examples, the printhead shield 106 may include multiple openings to line up with multiple dies of the printhead 104.

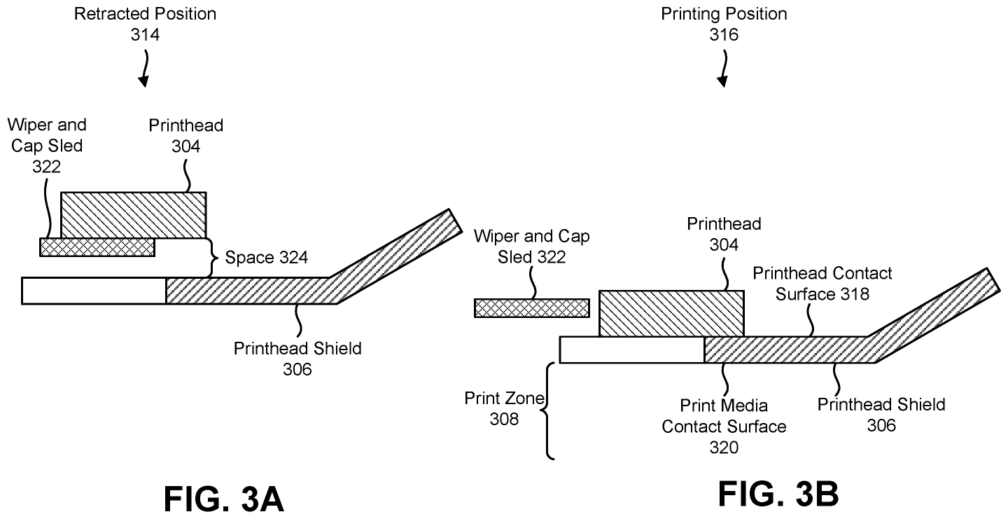

While the printhead shield 106 is depicted as a flat plate in FIG. 1, the printhead shield 106 may have other shapes or configurations. For example, the printhead shield 106 may have an angled and/or beveled leading edge on the input side. This shape may facilitate movement of the print media 110 entering the print zone 108 without the print media 110 catching on the printhead shield 106. Examples of additional printhead shield configurations are described in connection with FIGS. 3-5.

The printhead shield 106 may move in relation to the printhead 104. For example, when in the printing position the printhead shield 106 engages the printhead 104. When in the retracted position the printhead shield 106 separates from the printhead 104. As used herein, the retracted position is described in terms of being above the printing position. However, the printing device 102 may have other orientations. For example, the printhead 104 may be located below the print media 110, in which case, the retracted position is below the printing position.

When the printhead 104 moves from the retracted position to the printing position, there is initially a space separating the printhead 104 and the printhead shield 106. As the printhead 104 moves toward the printing position, a surface of the printhead 104 contacts the printhead shield 106. The printhead 104 then pushes the printhead shield 106 to the printing position and continues to go into the print zone 108 with the printhead shield 106 moving along with the printhead 104. In some examples, the printhead shield 106 may press against the shroud of the printhead 104. In this way, the printhead shield 106 protects the printhead 104.

Additionally, the printhead shield 106 may maintain a print height between the printhead 104 and the print media 110. The printhead shield 106 may ensure a fixed print height for the printhead 104. For example, there is no adjustment used to vary the print height of the printhead 104 when printing on varying print media thicknesses. Instead, once the printhead shield 106 contacts the print media 110, the printhead shield 106 provides a fixed offset of the printhead 104 from the print media 110. This offset is referred to as the print height (e.g., separation) of the printhead 104 from the print media 110.

When the printhead 104 moves to the retracted position from the printing position, the printhead shield 106 disengages from the printhead 104 to form a space between the printhead 104 and the printhead shield 106. For example, as the printhead 104 moves back up to the retracted position after printing, the printhead 104 separates from contacting the printhead shield 106. When in the retracted position, the printhead 104 may be separated from the printhead shield 106 by a distance.

The printhead shield 106 may move vertically within the print zone 108 to accommodate variable print media thickness. For example, once the printhead 104 engages the printhead shield 106, the printhead 104 and the printhead shield 106 may move down into the print zone 108. The printhead and printhead shield motion 114 may be adjusted to the height of the print media 110.

In some examples, the printing device 102 may include a printhead elevator. The printhead elevator may actuate (e.g., move) the printhead 104 from the retracted position to the printing position, back to the retracted position and so forth. When the printhead elevator actuates the printhead 104 to the printing position, the printhead 104 engages the printhead shield 106. When the printhead elevator actuates the printhead 104 to the retracted position, the printhead 104 separates from the printhead shield 106.

In some examples, the printing device 102 may include a wiper and cap sled. The wiper and cap sled may engage the printhead 104. For example, wipers on the wiper and cap sled may wipe print substance from the nozzles of the printhead 104. A cap may seal the nozzles when the printhead 104 is not printing. The printhead shield 106 may be below the wiper and cap sled when the printhead 104 is wiped and capped.

When actuating the printhead 104 to the retracted position, the wiper and cap sled may enter the space between the printhead 104 and the printhead shield 106 to wipe and cap the printhead 104. When actuating the printhead 104 to the printing position, the wiper and cap sled moves out of the space between the printhead 104 and the printhead shield 106 to permit the printhead 104 to engage the printhead shield 106. When printing, the wiper and cap sled move back from the printhead 104 and the printhead 104 moves down to the print zone 108 with the printhead shield 106.

In an example, the printhead shield 106 may be supported by springs or other elastic mechanism (e.g., elastomer). For instance, the printhead shield 106 may be suspended from springs from above. In another implementation, the printhead shield 106 may sit on springs located below a mounting point on the printhead shield 106. The springs may cause the printhead shield 106 to press against the printhead 104 when the printhead 104 moves into the printing position. Guiding features of the printing device 102 may permit the printhead shield 106 to move in the same axis as the printhead 104, but the guiding features may prevent movement of the printhead shield 106 in other directions (e.g., lateral movement). The springs may support the printhead shield 106 on the printing device 102 when the printhead 104 separates from the printhead shield 106.

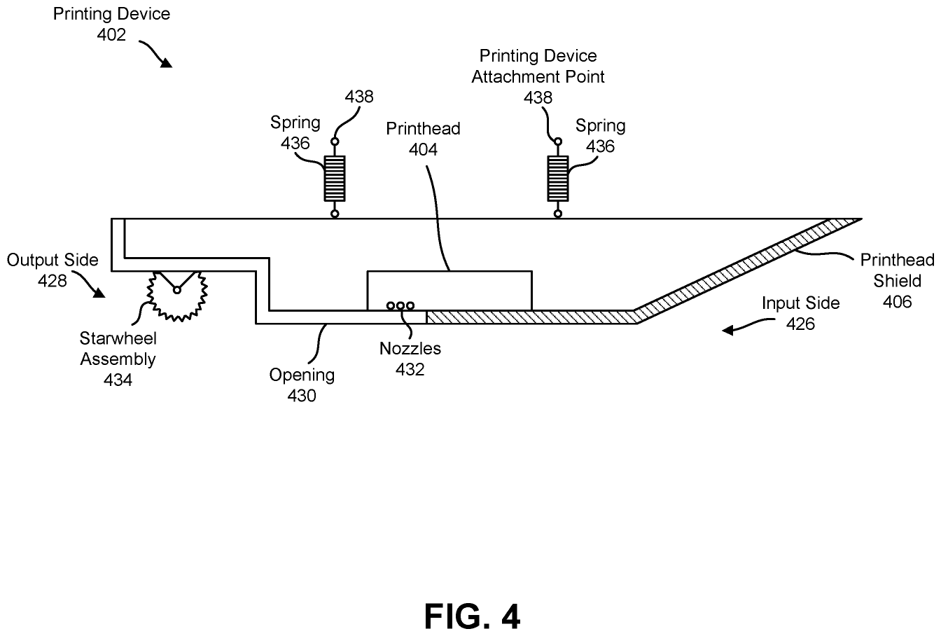

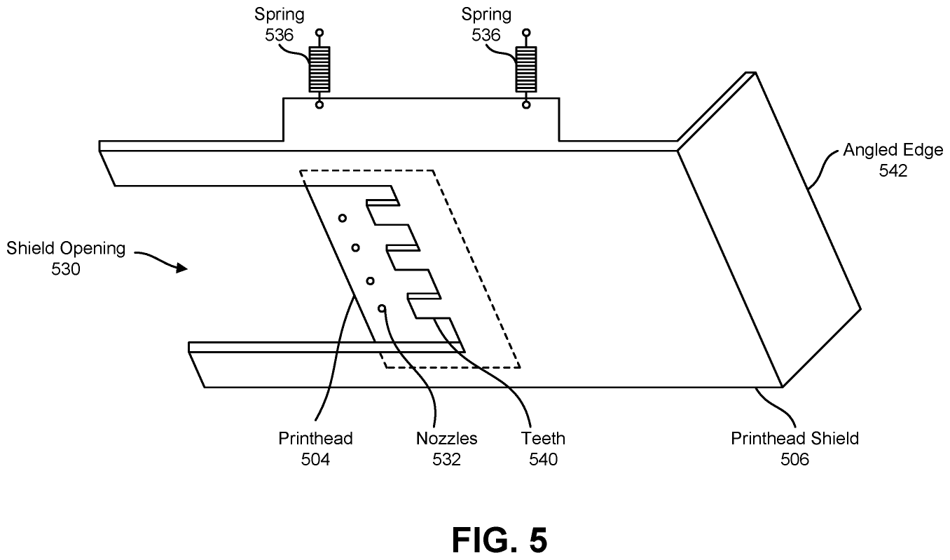

Some additional aspects of a printing device 102 with a floating printhead shield 106 are described herein. Examples of the printhead 104 and printhead shield 106 in different positions are described in FIG. 3. Additional details of the printhead shield 106 and printhead 104 are described in FIG. 4 and FIG. 5.

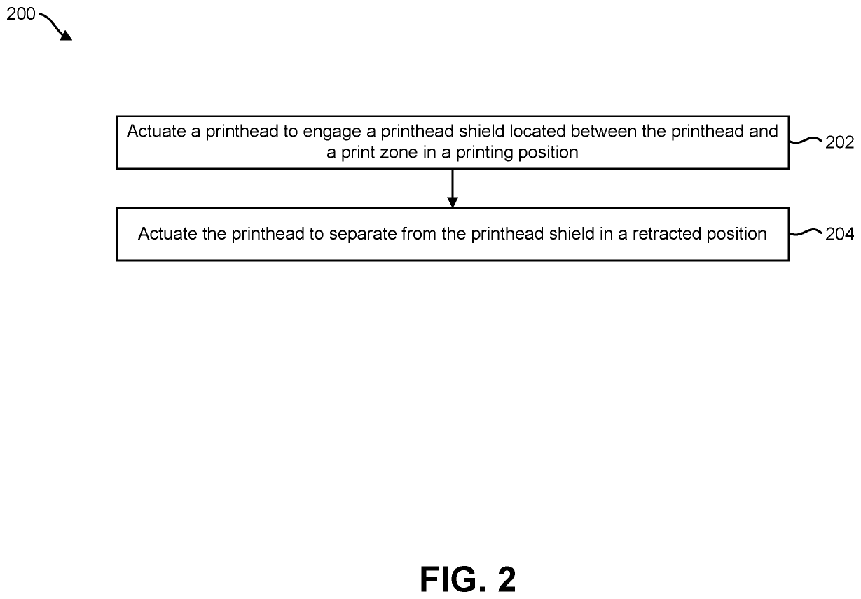

FIG. 2 is an example flow diagram illustrating a method 200 for actuating a printhead 104. The method 200 may be implemented by a printing device 102 having a printhead 104 and a printhead shield 106 located between the printhead 104 and a print zone 108.

The printing device 102 may actuate 202 the printhead 104 to engage the printhead shield 106 in a printing position. For example, a printhead elevator may actuate (e.g., move) the printhead 104 to the printing position. While moving to the printing position, the printhead 104 may engage the printhead shield 106. The printhead 104 may contact the printhead shield 106 and may push the printhead shield 106 to the printing position.

When in the printing position, the printhead shield 106 may maintain the print height between the printhead 104 and the print media 110. The printhead shield 106 protects the printhead 104 from the print media 110. The printhead shield 106 may move vertically within the print zone 108 to accommodate variable print media thickness. The printhead shield 106 may include an input side to hold down the print media 110 entering the print zone 108 and an output side with an opening to permit transfer of a print substance from the printhead 104 to the print media 110.

When actuating 202 the printhead 104 to the printing position, a wiper and cap sled may move out of the space between the printhead 104 and the printhead shield 106. Once the wiper and cap sled moves out of the space, the printhead 104 may be permitted to engage the printhead shield 106.

The printing device 102 may actuate 204 the printhead 104 to separate from the printhead shield 106 in a retracted position. For example, the printhead elevator may move the printhead 104 to the retracted position. While moving to the retracted position, the printhead 104 disengages from the printhead shield 106. When in the retracted position, the printhead 104 is separated from the printhead shield 106 forming a space between the printhead 104 and the printhead shield 106.

When actuating 204 the printhead to the retracted position, the wiper and cap sled may enter the space between the printhead 104 and the printhead shield 106. The wiper and cap sled may wipe and cap the printhead 104.

FIGS. 3A and 3B are examples illustrating a printhead 304 and a printhead shield 306 in a retracted position 314 and a printing position 316. The printhead 304 and the printhead shield 306 may be implemented according to the printhead 104 and printhead shield 106 as described in FIG. 1.

In FIG. 3A, the printhead 304 and the printhead shield 306 are in a retracted position 314. When in the retracted position 314, the printhead 304 is separated from the printhead shield 306. This separation forms a space 324 between the printhead 304 and the printhead shield 306. A wiper and cap sled 322 may enter the space 324 between the printhead 304 and the printhead shield 306 to wipe and cap the printhead 304.

In FIG. 3B, the printhead 304 and the printhead shield 306 are in a printing position 316. When in the printing position 316, the printhead 304 engages a printhead contact surface 318 of the printhead shield 306. A print media contact surface 320 of the printhead shield 306 may contact print media in the print zone 308.

It should be noted that the printhead shield 306 maintains the print height between the printhead 304 and the print media. For example, thickness of the printhead shield 306 may provide a fixed separation distance between the printhead 304 and the print media.

When in the printing position 316, the wiper and cap sled 322 may be withdrawn from between the printhead 304 and the printhead shield 306. In other words, when the printhead 304 and printhead shield 306 move from the retracted position 314 to the printing position 316, the wiper and cap sled 322 may move out of the space 324 between the printhead 304 and the printhead shield 306 to permit the printhead 304 to engage the printhead shield 306.

FIG. 4 is a section view illustrating an example of a printhead shield 406 and a printhead 404 for a printing device 402. In FIG. 4, the printhead 404 and printhead shield 406 are shown in a printing position in which the printhead 404 contacts the printhead shield 406. It should be noted that the printhead 404 may also separate from the printhead shield 406 when in a retracted position.

The printhead shield 406 may have an input side 426 and an output side 428. Print media may pass from the input side 426 to the output side 428. The input side 426 may hold down the print media entering the print zone. For example, the printhead shield 406 may be a continuous plate on the input side 426. The printhead shield 406 may also have an angle or bevel on the input side 426 to facilitate movement of the print media without catching the printhead shield 406.

The output side 428 may have an opening 430 (referred to as a shield opening). The opening 430 may permit transfer of a print substance from the printhead 404 to the print media. For example, the opening 430 may align with nozzles 432 of the printhead 404.

The printhead shield 406 may be supported by springs 436. In this example, the printhead shield 406 is supported on the printing device 402 by gimbals on extension springs 436. In another implementation, the printhead shield 406 may sit on compression springs located below a mounting point on the printhead shield 406. The springs 436 may cause the printhead shield 406 to press against the printhead 404 when the printhead 404 moves into the printing position.

The springs 436 may attach to the printing device 402 at an attachment point 438. For example, the attachment point 438 may be on a frame of the printing device 402. The springs 436 may be attached to the printhead shield 406 at a location outside of the printhead 404. The printhead 404 may be driven down to the print zone to a distance determined by the thickness of the print media. Therefore, the print height may be the same, but the thickness of the media can vary from job to job.

As the printhead 404 comes down into the print zone, the printhead 404 pushes the floating printhead shield 406 such that printhead shield 406 presses up against the shroud of the printhead 404. During printing, the printhead shield 406 is held firmly up against the printhead 404, protecting the printhead 404 from the print media below. Then, when the printhead 404 goes back into the retracted position (e.g., the capped storage position), the printhead 404 may travel up above the printhead shield 406 far enough so that the wiper and cap sled can access the printhead 404. Thus, the printhead shield 406 may float on the springs 436 in between the printhead 404 and the print media, rather than attach to the printhead 404. This may provide a space for the wiper and cap sled to wipe and cap the printhead 404.

In some examples, a starwheel assembly 434 may be coupled to the output side 428 of the printhead shield 406. For example, the starwheel assembly 434 may be attached to a portion of the printhead shield 406. The starwheel assembly 434 may aid in print media transport. The movement (e.g., vertical movement) of the starwheel assembly 434 may be controlled by printhead shield movement. In other words, because the starwheel assembly 434 is attached to the printhead shield 406, the starwheel assembly 434 moves with the printhead shield 406. This may further facilitate accommodating print media with varying thickness.

FIG. 5 is a perspective view illustrating an example of a printhead shield 506 and a printhead 504 for a printing device. In FIG. 5, the printhead 504 and printhead shield 506 are shown from a bottom perspective. A print media contact surface of the printhead shield 506 is visible in FIG. 5.

The printhead 504 is shown in a printing position in which the printhead 504 contacts the printhead shield 506. Nozzles 532 of the printhead 504 align with the opening 530 of the printhead shield 506. The opening 530 may permit transfer of a print substance from the nozzles 532 of the printhead 504 to the print media.

In some examples, the printhead shield 506 may include a number of teeth 540 that project into the opening 530. The teeth 540 may further protect the printhead 504 from the print media.

In some examples, the printhead shield 506 may have an angled edge 542 to facilitate movement of the print media without catching the printhead shield 506. The print media entering the print zone may first encounter the angled edge 542. Upon contacting the angled edge 542, the print media may be placed into position for printing by the printhead 504. The printhead shield 506 may then hold down the print media entering the print zone.

It should be noted that while the example of FIG. 5 includes an angled edge 542 formed by a bend in the printhead shield 506, other implementations may employ different shapes to facilitate movement of the print media. For example, the printhead shield 506 may have a beveled, rounded or curved edge on the input side.

The printhead shield 506 may be supported by springs 536. This may be accomplished as described in FIG. 4. In this example, the printhead shield 506 includes tabs to attach to extension springs 536.

1. A printing device, comprising:
a printhead shield located between a printhead and a print zone, wherein when in a printing position the printhead shield engages the printhead, and when in a retracted position the printhead shield separates from the printhead.

2. The printing device of claim 1, wherein the printhead contacts the printhead shield and pushes the printhead shield to the printing position.

3. The printing device of claim 1, wherein in the retracted position the printhead shield disengages from the printhead to form a space between the printhead and the printhead shield.

4. The printing device of claim 1, wherein springs support the printhead shield on the printing device when the printhead separates from the printhead shield.

5. The printing device of claim 1, further comprising a starwheel assembly coupled to an output side of the printhead shield, wherein starwheel assembly movement is controlled by printhead shield movement.

6. A printhead shield, comprising:
a printhead contact surface to engage a printhead; and
a print media contact surface to engage print media in a print zone, wherein when in a printing position the printhead shield engages the printhead, and when in a retracted position the printhead shield separates from the printhead.

7. The printhead shield of claim 6, wherein when in the printing position, the printhead shield maintains a print height between the printhead and print media.

8. The printhead shield of claim 6, wherein the printhead shield protects the printhead from the print media.

9. The printhead shield of claim 6, wherein the printhead shield moves vertically within the print zone to accommodate variable print media thickness.

10. The printhead shield of claim 6, wherein the printhead shield comprises an input side to hold down the print media entering the print zone and an output side with an opening to permit transfer of a print substance from the printhead to the print media.

11. A method, comprising:
actuating a printhead to engage a printhead shield located between the printhead and a print zone in a printing position; and
actuating the printhead to separate from the printhead shield in a retracted position.

12. The method of claim 11, wherein a printhead surface contacts the printhead shield and pushes the printhead shield to the printing position.

13. The method of claim 11, wherein a printhead elevator actuates the printhead to the printing position to engage the printhead shield.

14. The method of claim 13, wherein the printhead elevator actuates the printhead to the retracted position to separate the printhead from the printhead shield.

15. The method of claim 11, wherein when actuating the printhead to the retracted position, a wiper and cap sled enters a space between the printhead and the printhead shield to wipe and cap the printhead, and wherein when actuating the printhead to the printing position, the wiper and cap sled moves out of the space between the printhead and the printhead shield to permit the printhead to engage the printhead shield.
